(19) United States
(12) Patent Application Publication
(10) Pub. No.: US 2019/0179575 A1
(43) Pub. Date: Jun. 13, 2019

(54) MAINTENANCE DATA PROVIDING SYSTEM, SERVER, AND INFORMATION PROCESSING METHOD

(71) Applicant: TOSHIBA TEC KABUSHIKI KAISHA, Tokyo (JP)

(72) Inventor: Jun Iwamoto, Shizuoka (JP)

(21) Appl. No.: 16/214,407

(22) Filed: Dec. 10, 2018

(30) Foreign Application Priority Data
Dec. 11, 2017 (JP) 2017-236759

(51) Int. Cl. G06F 3/12; G06F 16/958; G06F 16/955; G06F 16/954; H04L 29/08; H04M 1/725

(52) U.S. Cl. CPC G06F 3/1204; G06F 16/958; G06F 16/9566; H04L 67/42; H04L 67/02; G06F 3/1232; H04M 1/72561; G06F 16/954

(57) ABSTRACT

In accordance with an embodiment, a system comprises a device comprising an acquisition module, a request generation module and a request output module; and a server comprising a page generation module and a providing module. The acquisition module acquires maintenance data relating to the device. The request generation module generates request information including the maintenance data and requesting the server to provide a web page relating to the maintenance data. The request output module outputs the request information as the identification data in such a manner that it can be read by an information terminal. The page generation module generates a web page indicating the maintenance data included in the request information designated as the identification data in response to a request from the information terminal via the communication network. The providing module provides the web page to the information terminal as a response to the request.

### CROSS-REFERENCE TO RELATED APPLICATION

This application is based upon and claims the benefit of priority from Japanese Patent Application No. 2017-236759, filed on Dec. 11, 2017, the entire contents of which are incorporated herein by reference.

### FIELD

Embodiments described herein relate generally to a maintenance data providing system, a server, and an information processing method.

### BACKGROUND

It has been already conceivable to make it possible to browse various kinds of maintenance data relating to the maintenance of a device required to be maintained such as a printer using an information terminal by downloading the maintenance data from the device to a server and accessing the server with the information terminal.

However, such a technology is difficult to be realized unless the environment in which the device can communicate with the server is prepared. For example, in the case of a printer, in many cases, the printer is not directly connected to a communication network, and in such a case, maintenance data cannot be uploaded to the server.

For these reasons, it is desired to make it possible to browse the maintenance data of the device which is not in the environment in which the device can communicate with the server using the information terminal.

### DESCRIPTION OF THE DRAWINGS

FIG. 1 is a block diagram illustrating a schematic configuration of a maintenance data providing system according to an embodiment, and circuit configurations of main portions of a printer and a server constituting the maintenance data providing system;

FIG. 2 is a flowchart depicting procedures of an information processing executed by a processor of the printer in FIG. 1; and

FIG. 3 is a flowchart depicting procedures of an information processing executed by a processor of the server in FIG. 1.

### DETAILED DESCRIPTION

In accordance with an embodiment, a maintenance data providing system, which comprises a device and a server, provides a web page indicating maintenance data relating to maintenance of the device to an information terminal having a function of requesting provision of a web page identified by identification data via a communication network and outputting the web page provided via the communication network in response to the request. The device includes an acquisition module configured to acquire predetermined maintenance data relating to the device; a request generation module configured to generate request information including the maintenance data acquired by the acquisition module and requesting the server to provide a web page relating to the maintenance data; and a request output module configured to output the request information generated by the request generation module as identification data in such a manner that it can be read using an information terminal. The server includes a page generation module configured to generate a web page indicating the maintenance data included in the request information designated as the identification data in response to a request from the information terminal via the communication network, and a providing module configured to provide the web page generated by the page generation module to the information terminal via the communication network as a response to the request.

Hereinafter, an embodiment is described with reference to the accompanying drawings. In the present embodiment, a device required to be maintained is a printer.

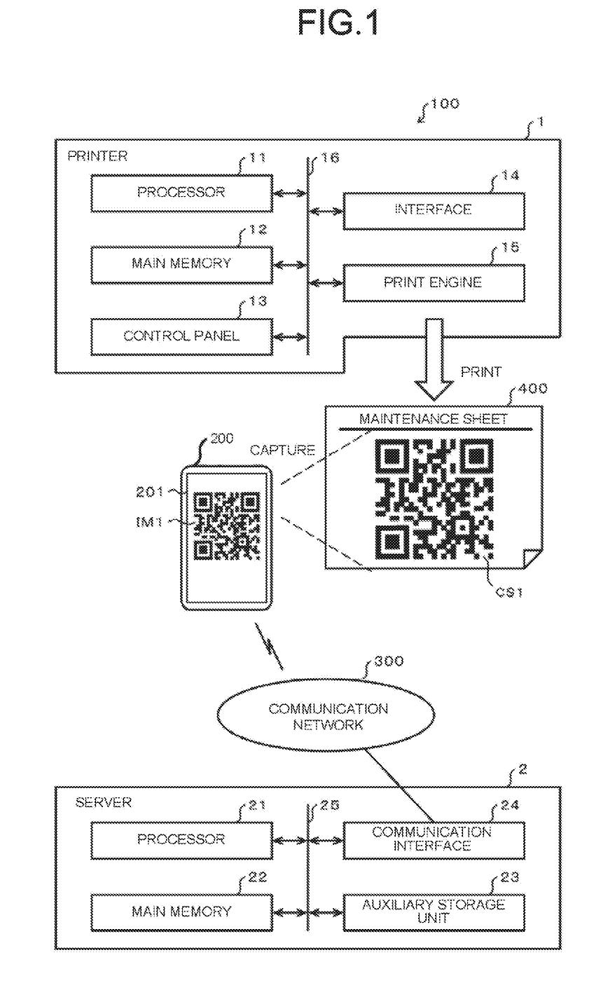

FIG. 1 is a block diagram illustrating a schematic configuration of a maintenance data providing system 100 according to the present embodiment, and circuit configurations of main portions of a printer 1 and a server 2 constituting the maintenance data providing system 100.

The maintenance data providing system 100 includes the printer 1 and the server 2. Then, in the maintenance data providing system 100, a smartphone 200 can be used to confirm maintenance data relating to the maintenance of the printer 1.

The printer 1 includes a processor 11, a main memory 12, a control panel 13, an interface 14, a print engine 15, and a transmission line 16.

In the printer 1, the processor 11 and the main memory 12 are connected to each other via the transmission path 16 to constitute a computer for executing an information processing for controlling the printer 1. The printer 1 further includes an auxiliary storage unit connected to the transmission line 16, and the computer may further include the auxiliary storage unit as an auxiliary storage portion thereof. The auxiliary storage unit may be, for example, an EEPROM (electric erasable programmable read-only memory), an HDD (hard disc drive), an SSD (solid state drive), or other well-known various storage devices.

The processor 11 acts as a central portion of the computer. The processor 11 controls each section to realize various functions of the printer 1 by executing an information processing program such as an operating system and an application program.

The main memory 12 acts as a main storage portion of the computer. The main memory 12 includes a nonvolatile memory area and a volatile memory area. The main memory 12 stores the operating system and the application program in the nonvolatile memory area. The main memory 12 may store data necessary for the processor 11 to execute a processing to control each section in the nonvolatile or volatile memory area in some cases. The main memory 12 uses the volatile memory area as a work area where data is appropriately rewritten by the processor 11.

The control panel 13 inputs an operation performed by a user and performs a display to provide various kinds of information to the user. The control panel 13 may appropriately include various operation devices and display devices such as a touch panel, a keyboard, a key switch, an LED (Light Emitting Diode) lamp, a liquid crystal display panel, and the like.

An information terminal such as a POS (point-of-sale) terminal is connected to the interface 14. The interface 14 performs a processing for establishing data communication with a connected information terminal.

The print engine 15 prints an image indicated by the image data on a print medium such as a paper. As the print engine 15, a device of a well-known system such as an electrophotographic system, a thermal transfer system, a thermal system, an impact dot system, or the like may be appropriately used.

The transmission path 16 includes an address bus, a data bus, a control signal line, and the like, and transmits data and a control signal transmitted and received between the connected sections.

The server 2 includes a processor 21, a main memory 22, an auxiliary storage unit 23, a communication interface 24, and a transmission line 25.

In the server 2, the processor 21, the main memory 22, and the auxiliary storage unit 23 are connected to each other via the transmission line 25 to constitute a computer that performs an information processing for controlling the server 2.

The processor 21 acts as a central portion of the computer. The processor 21 controls each section to realize various functions of the server 2 by executing an information processing program such as an operating system and an application program.

The main memory 22 acts as a main storage portion of the computer. The main memory 22 includes a nonvolatile memory area and a volatile memory area. The main memory 22 stores the operating system and the application program in the nonvolatile memory area. The main memory 22 may store data necessary for the processor 21 to execute a processing to control each section in the nonvolatile or volatile memory area in some cases. The main memory 22 uses the volatile memory area as a work area where data is appropriately rewritten by the processor 21.

The auxiliary storage unit 23 acts as an auxiliary storage portion of the computer. The auxiliary storage unit 23 may be, for example, an EEPROM, an HDD, an SSD, or other well-known storage devices. The auxiliary storage unit 23 stores data used by the processor 21 to perform various processing and data generated in the processing by the processor 21. The auxiliary storage unit 23 may also store the application program.

The communication interface 24 performs data communication via a communication network 300. The communication interface 24 may be, for example, a well-known device for performing a known processing for establishing data communication via the Internet. The communication interface 24 acts as a communication device that performs data communication via the communication network 300.

The transmission line 25 includes an address bus, a data bus and a control signal line, and transmits data and control signals transmitted and received between the connected sections.

Next, the operation of the maintenance data providing system 100 configured as described above is described.

A worker who performs maintenance of the printer 1 or an administrator of the printer 1 instructs display by performing a predetermined operation on the control panel 13 of the printer 1 when he/she wants to confirm the maintenance data relating to the printer 1. In response to this, the processor 11 executes the following information processing by executing the application program stored in the main memory 12.

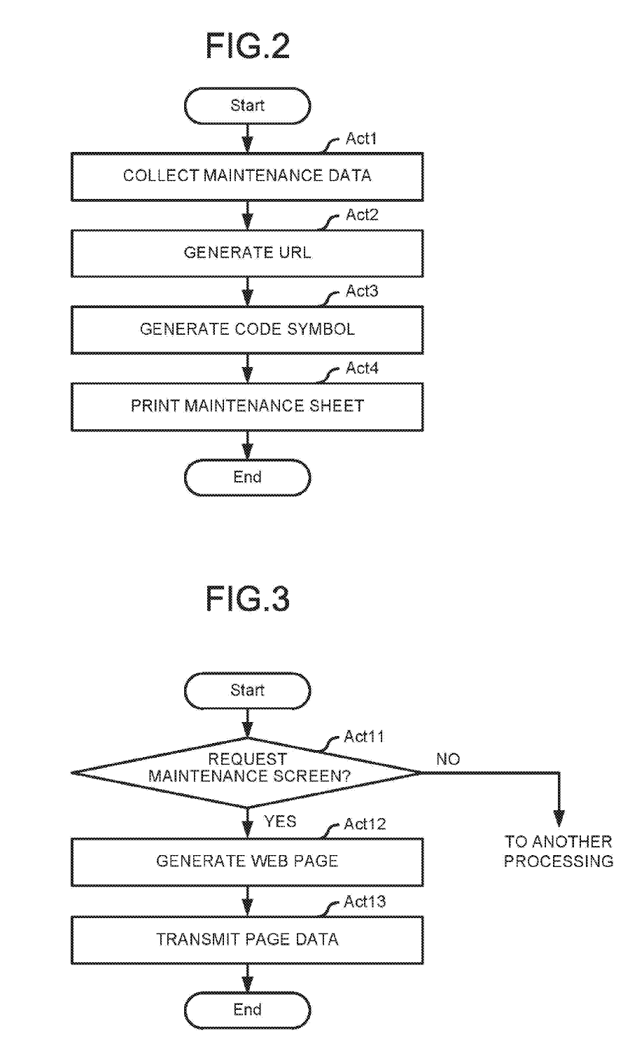

FIG. 2 is a flowchart depicting procedures of the information processing executed by the processor 11.

In Act 1, the processor 11 collects predetermined maintenance data as maintenance data relating to the maintenance of the printer 1. For example, the maintenance data may be arbitrarily determined by a designer or an administrator of the printer 1. The maintenance data is various kinds of setting information such as a printing density, information indicating an operation state such as the number of printed sheets, and the like. Thus, the processor 11 executes the application program to execute the information processing, and in this way, the computer having the processor 11 as the central portion functions as an acquisition module for acquiring the maintenance data.

In Act 2, the processor 11 generates a URL (Uniform Resource Locator). This URL accesses the server 2 to request the server 2 to provide a browsing screen for browsing the maintenance data. As an example, the URL may be “http://www.XXXXXXXX.com/smartmaintenance/shows?sid=7598631 &fw=1.52&rlong=75864”. Here, “XXXXXXXX.com” is a domain name for identifying the server 2 on the communication network 300. The “smartmaintenance/shows?” is a command for requesting the server 2 to provide a web page indicating maintenance data following “shows?”. The “sid=7598631&fw=1.52&rlong=75864” indicates the collected maintenance data as a character string arranged in a predetermined format. “&” indicates a partition of maintenance data, and “sid”, “fw” and “rlong” indicate the type of the maintenance data. The numerical value after “=” is the collected maintenance data. Thus, the URL is an example of the request information for requesting the server 2 to provide a web page identified by the character string “sid=7598631&fw=1.52&rlong=75864”. The character string “sid=7598631&fw=1.52&rlong=75864” corresponds to the identification data for identifying the web page. Thus, the processor 11 executes the application program to execute the information processing, and in this way, the computer having the processor 11 as the central portion functions as a request generation module for generating the request information.

In Act 3, the processor 11 generates a code symbol in which the URL generated in Act 2 is shown in conformity to a predetermined standard. Although the standard of the code symbol may be any standard, it is assumed that a QR Code® is used.

In Act 4, the processor 11 controls the print engine 15 to print a maintenance sheet 400 on which a code symbol CS1 generated in Act 3 is displayed in an optically readable manner. However, the maintenance sheet 400 shown in FIG. 1 is merely an example. The form of the maintenance sheet may be any form determined, for example, by a designer or the like of the printer 1. In this manner, the processor 11 outputs the URL as the request information by printing the code symbol CS1 indicating the URL generated in Act 2. Thus, the processor 11 executes the application program to execute the information processing, and in this way, the computer having the processor 11 as the central portion functions as a request output module in cooperation with the print engine 15.

Then, if the printing of the maintenance sheet 400 is completed, the processor 11 terminates the information processing shown in FIG. 2.

The operator or the administrator starts an application of a code reader corresponding to the format of the code symbol CS1 included in the maintenance sheet 400 using the smartphone 200 to read the code symbol CS1. The smartphone 200 analyzes the image data obtained by photographing the code symbol CS1 with the camera to acquire the data indicated by the code symbol CS1. In FIG. 1, a state in which the code symbol CS1 is photographed by the camera of the smartphone 200 is shown. On a display 201 of the smartphone 200, an image IM1 obtained by photographing the code symbol CS1 is displayed. The application of the code reader may be general-purpose application. Many of the general-purpose code readers instruct web access according to the URL to a web browser automatically or by receiving a connection instruction from the operator when the code symbol indicating the URL is received. Specifically, a command and maintenance data accessed from the smartphone 200 via the communication network 300 to the server 2 and contained in the URL are provided to the server 2.

If the server 2 receives an access via the communication network 300 in this way, the processor 21 executes an information processing as described below by executing the application program stored in the main memory 22 or the auxiliary storage unit 23.

FIG. 3 is a flowchart depicting an information processing executed by the processor 21.

In Act 11, the processor 21 determines whether or not the provision of the maintenance screen is requested in the access. Then, if a command for requesting the provision of the maintenance screen is not notified, the processor 21 determines No, and shifts to another processing. If it is assumed that the server 2 has only a function of providing the maintenance screen, the processor 21 may terminates the processing in FIG. 3 in response to determination of No in Act 11. On the other hand, if the access from the smartphone 200 is received as described above, the processor 21 determines Yes in Act 11 and proceeds to the processing in Act 12.

In Act 12, the processor 21 generates a maintenance screen indicating the content of the maintenance data as a web page. For example, the processor 21 generates the web page by adding information indicated by the maintenance data to a form of a predetermined web page. The processor 21 may appropriately include data different from the maintenance data, such as guidance for determining a timing at which the maintenance is required to be performed, in the web page. Thus, the processor 21 executes the application program to execute the information processing, and in this way, the computer having the processor 21 as the central portion functions as a page generation module.

In Act 13, the processor 21 transmits page data indicating the web page generated in Act 12 as a response to the above access to the smartphone 200 from the communication interface 24 via the communication network 300. If the transmission is terminated, the processor 21 terminates the information processing shown in FIG. 3. As a result, the web page is provided to the smartphone 200. Thus, the processor 21 executes the application program to execute the information processing, and in this way, the computer having the processor 21 as the central portion functions as a providing module in cooperation with the print engine 15. The computer having the processor 11 as the central portion functions as a providing control module.

If the page data is received, the smartphone 200 displays the web page indicating the content of the maintenance data on a display device with the general-purpose web browser.

As described above, according to the maintenance data providing system 100, the maintenance data is notified from the printer 1 to the server 2 via the smartphone 200. Therefore, the printer 1 does not need to upload the maintenance data to the server 2, and the environment in which the printer 1 and the server 2 can directly communicate with each other becomes unnecessary.

According to the maintenance data providing system 100, the smartphone 200 can display the web page indicating the content of the maintenance data using the general-purpose code reader and the general-purpose web browser. In other words, it is conceivable to generate a maintenance screen on the smartphone 200 based on the maintenance data included in the code symbol CS1. In this case, it is necessary for the smartphone 200 to have that function. However, that function is not a standard function of the smartphone 200. However, in the maintenance data providing system 100, many smartphones only use the standard function.

According to the maintenance data providing system 100, the URL is used as the request information given from the printer 1 to the smartphone 200. Therefore, it is possible for most of the various web browsers on the smartphone 200 to process the request for providing the maintenance screen.

By using the maintenance data as in the above example, a person who has knowledge about the form of the maintenance data and the maintenance of the printer 1 to some extent can understand the content of the maintenance data from the character string of the maintenance data.

The present embodiment can be modified as follows.

The request information may be data in a form different from that of the URL.

The maintenance data does not need to be the character string but may be coded data.

The smartphone 200 may acquire the request information by wireless communication such as NFC (Near Field Communication), infrared communication, or the like.

Instead of the printer 1, any device requiring maintenance may be applied as the device.

As the information terminal, in place of the smartphone 200, any other devices such as a tablet terminal or a portable personal computer may also be applied.

All or a part of the functions realized by the processor 11 or the processor 21 executing the information processing may be realized by hardware such as a logic circuit or the like for executing the information processing not based on a program. Each of the above-described functions may also be realized by combining software control with hardware such as the above logic circuit.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A maintenance data providing system comprising a device and a server, comprising:
the device, the server, and a component that provides a web page indicating maintenance data relating to maintenance of the device to an information terminal having a function of requesting provision of a web page identified by identification data via a communication network and outputting the web page provided via the communication network in response to the request,
the device comprising:
an acquisition module configured to acquire predetermined maintenance data relating to the device;
a request generation module configured to generate request information including the maintenance data acquired by the acquisition module and to request the server to provide a web page relating to the maintenance data; and
a request output module configured to output the request information generated by the request generation module as the identification data so that the request information is readable by an information terminal, and
the server comprising:
a page generation module configured to generate a web page indicating the maintenance data included in the request information designated as the identification data in response to a request from the information terminal via the communication network; and
a providing module configured to provide the web page generated by the page generation module to the information terminal via the communication network as a response to the request.

2. The maintenance data providing system according to claim 1, wherein
the request generation module generates a URL as the request information.

3. The maintenance data providing system according to claim 2, wherein
the request generation module shows the maintenance data as a character string following a character string for specifying the server on the communication network in the URL.

4. The maintenance data providing system according to claim 1, wherein
the device is a printer.

5. The maintenance data providing system according to claim 1, wherein
the information terminal is a POS terminal.

6. The maintenance data providing system according to claim 1, wherein
the information terminal is a smartphone.

7. The maintenance data providing system according to claim 1, wherein
the maintenance data comprises a character string or coded data.

8. A server for a maintenance data providing system, the server comprising a processor comprising:
a page generation module configured to generate a web page indicating maintenance data relating to a device included in request information designated as the identification data in response to a request from an information terminal via a communication network; and
a providing module configured to provide the web page generated by the page generation module to the information terminal via the communication network as a response to the request from the information terminal.

9. The server according to claim 8, wherein
the request information comprises a URL.

10. The server according to claim 9, wherein
the maintenance data comprises a character string following a character string for specifying the server on the communication network in the URL.

11. The server according to claim 8, wherein
the device is a printer.

12. The server according to claim 8, wherein
the maintenance data comprises a character string or coded data.

13. An information processing method, comprising:
generating a web page indicating the maintenance data relating to the device included in request information designated as identification data in response to a request received by a communication device from an information terminal via a communication network; and
providing the web page indicating maintenance data relating to maintenance of the device to the information terminal having a function of requesting provision of a web page identified by identification data via the communication network and outputting the web page provided via the communication network in response to the request.

14. The information processing method according to claim 13, further comprising:
generating a URL as the request information.

15. The information processing method according to claim 14, wherein
the request information shows the maintenance data as a character string following a character string for specifying the server on the communication network in the URL.

16. The information processing method according to claim 13, wherein
the device is a printer.

17. The information processing method according to claim 13, wherein
the information terminal is a POS terminal.

18. The information processing method according to claim 13, wherein
the information terminal is a smartphone.

19. The information processing method according to claim 13, wherein
the maintenance data comprises a character string or coded data.
